(19) United States
(12) Patent Application Publication
(10) Pub. No.: US 2024/0333939 A1
(43) Pub. Date: Oct. 3, 2024

(54) MOTION COMPENSATION METHOD, APPARATUS, AND STORAGE MEDIUM

(71) Applicant: Alibaba (China) Co., Ltd., Hangzhou (CN)

(72) Inventors: Shuqing Fang, Hangzhou (CN); Jianhua Chen, Hangzhou (CN); Yan YE, San Diego, CA (US)

(21) Appl. No.: 18/616,964

(22) Filed: Mar. 26, 2024

(30) Foreign Application Priority Data
Mar. 28, 2023 (CN) 202310344603.2

(51) Int. Cl. H04N 19/139; H04N 19/156; H04N 19/176; H04N 19/182; H04N 19/48

(52) U.S. Cl. CPC H04N 19/139; H04N 19/156; H04N 19/176; H04N 19/182; H04N 19/48

(57) ABSTRACT

A motion compensation method, includes: acquiring a plurality of matching costs between a to-be-processed block and a plurality of first pixel blocks, the plurality of first pixel blocks corresponding to a plurality of integer pixels within a search range in a reference frame; based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and performing motion compensation on the to-be-processed block according to the plurality of matching costs and the plurality of approximate matching costs.

### CROSS-REFERENCE TO RELATED APPLICATIONS

The disclosure claims the benefits of priority to Chinese Application No. 202310344603.2, filed Mar. 28, 2023, which is incorporated herein by reference in its entirety.

### TECHNICAL FIELD

The present disclosure generally relates to image processing, and more particularly, to a motion compensation method, apparatus, and storage medium.

### BACKGROUND

Motion compensation is a method of describing the difference between adjacent frames (the term “adjacent” here means two frames being adjacent in terms of coding, and not necessarily adjacent in the play order), that is, describing how each block in the reference frame moves to a position in the current frame. Specifically, for each block, the pixel block most similar to the current block, i.e., the matching block, is found within a specific search range of the reference frame, and a Motion Vector (MV) (i.e., the positional coordinates of the matching block relative to the current block) is output, and then motion compensation is implemented based on the motion vector.

When searching for a matching block, an optimal integer pixel is first searched for in the search range, and then an optimal sub-pixel is searched for according to the optimal integer pixel obtained. The matching block is determined according to the optimal integer pixel and the optimal sub-pixel. Due to the large number of sub-pixels, the search is very complicated.

### SUMMARY OF THE DISCLOSURE

Embodiments of the present disclosure provide a motion compensation method. The method includes: acquiring a plurality of matching costs between a to-be-processed block and a plurality of first pixel blocks, the plurality of first pixel blocks corresponding to a plurality of integer pixels within a search range in a reference frame; based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and performing motion compensation on the to-be-processed block according to the plurality of matching costs and the plurality of approximate matching costs.

Embodiments of the present disclosure provide an apparatus for motion compensation. The apparatus includes a memory configured to store instructions; and one or more processors configured to execute the instructions to cause the apparatus to perform operations including: acquiring a plurality of matching costs between a to-be-processed block and a plurality of first pixel blocks, the plurality of first pixel blocks corresponding to a plurality of integer pixels within a search range in a reference frame; based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and performing motion compensation on the to-be-processed block according to the plurality of matching costs and the plurality of approximate matching costs.

Embodiments of the present disclosure provide a non-transitory computer-readable storage medium that stores a set of instructions that is executable by one or more processors of an apparatus to cause the apparatus to perform operations including: acquiring a plurality of matching costs between a to-be-processed block and a plurality of first pixel blocks, the plurality of first pixel blocks corresponding to a plurality of integer pixels within a search range in a reference frame; based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and performing motion compensation on the to-be-processed block according to the plurality of matching costs and the plurality of approximate matching costs.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a schematic diagram of an application scenario of an exemplary motion compensation method, according to some embodiments of the present disclosure.

FIG. 5 is a block diagram of an exemplary apparatus for encoding or decoding a video, according to some embodiments of the present disclosure.

FIG. 6 is a schematic diagram of hierarchical motion estimation by Motion Compensated Temporal Filter (MCTF), according to some embodiments of the present disclosure.

FIG. 7 is a flow chart of an exemplary motion compensation method, according to some embodiments of the present disclosure.

FIG. 8 is a schematic diagram of sub-pixel search, according to some embodiments of the present disclosure.

FIG. 9 is a structural block diagram of an exemplary motion compensation apparatus, according to some embodiments of the present disclosure.

FIG. 10 is a block diagram of an exemplary electronic device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

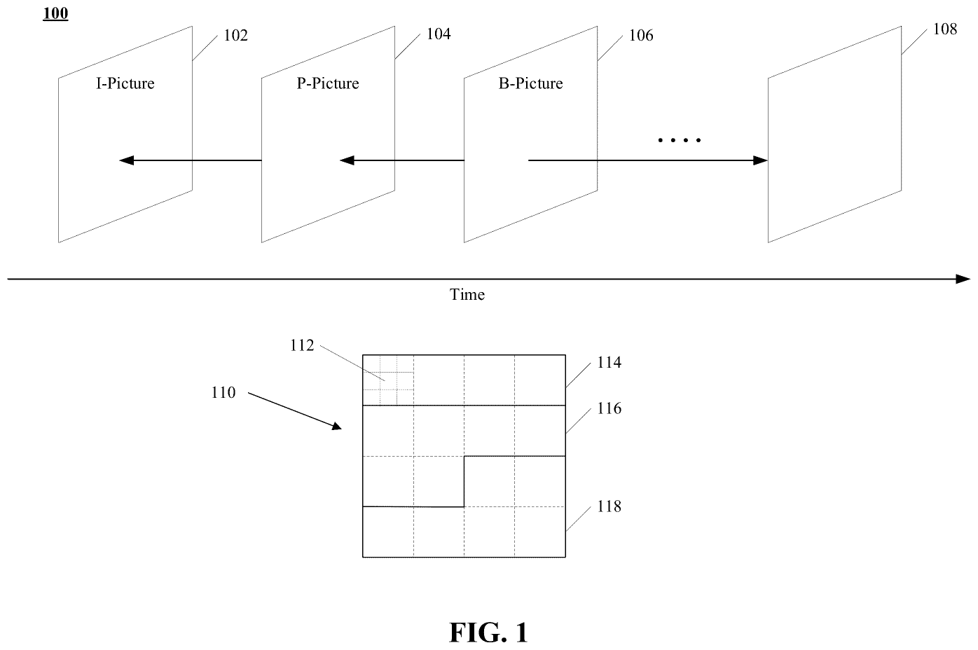

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

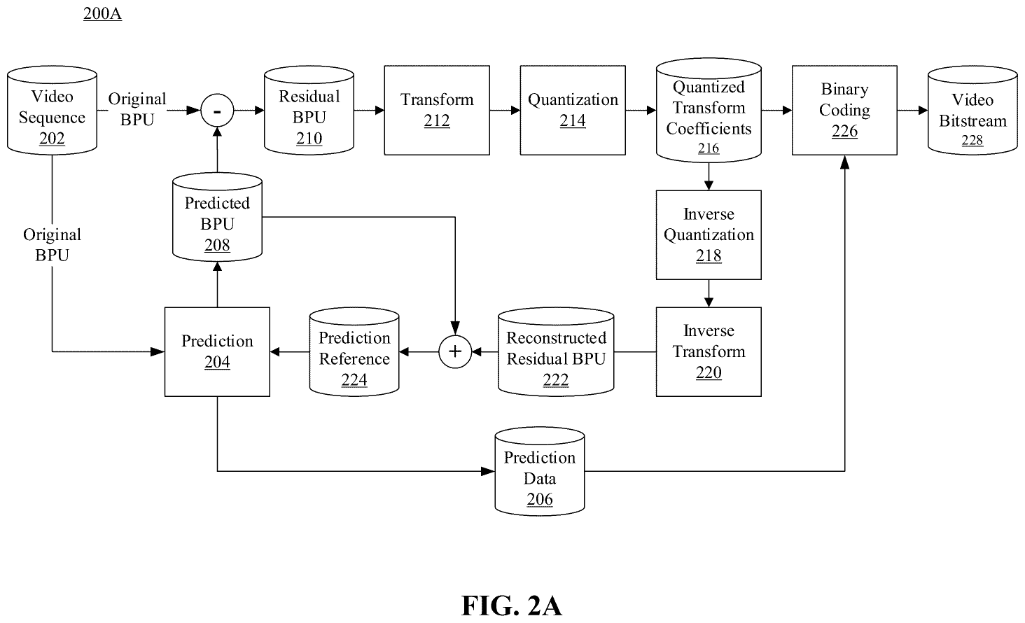

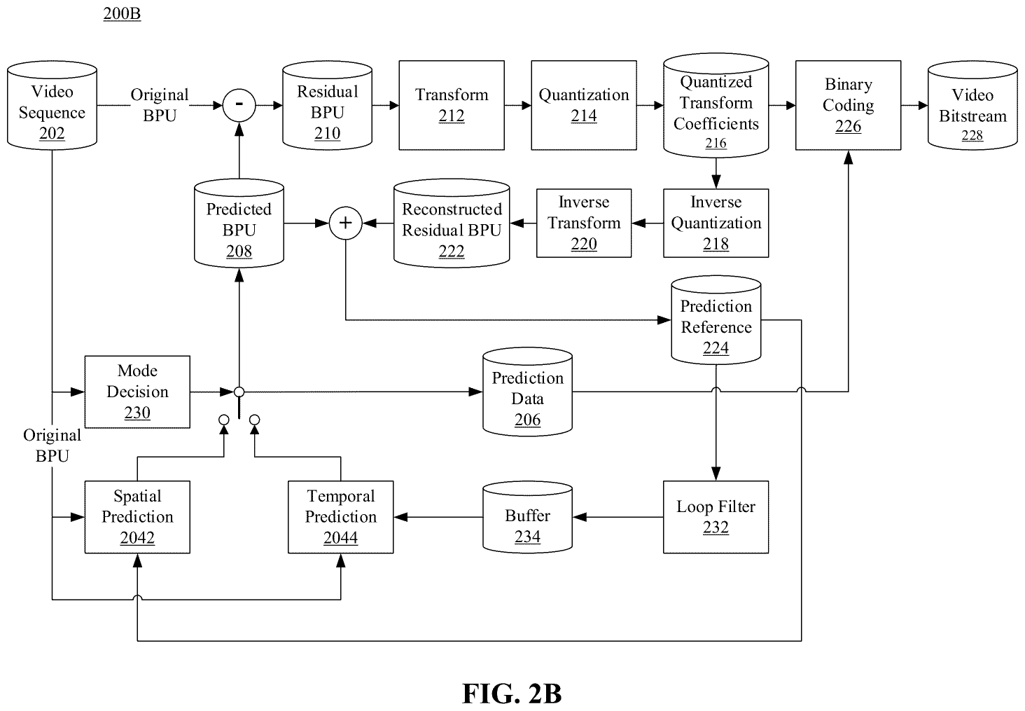

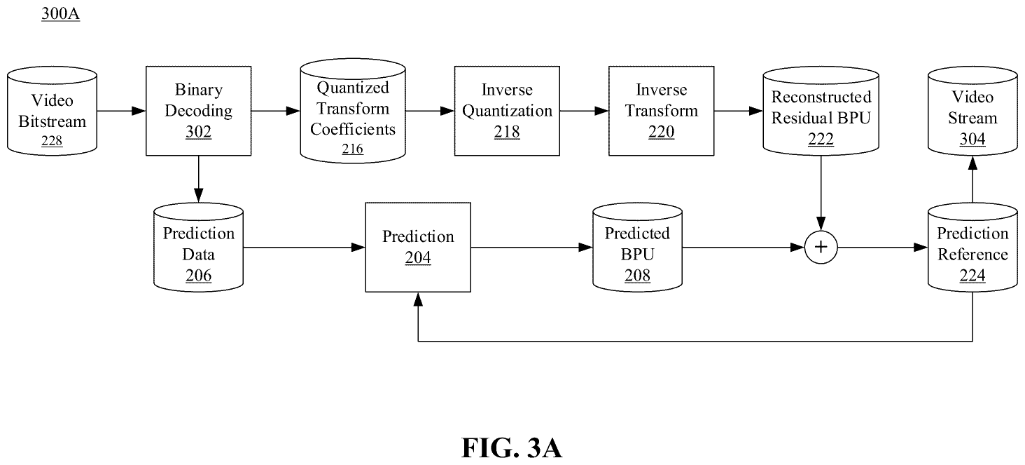

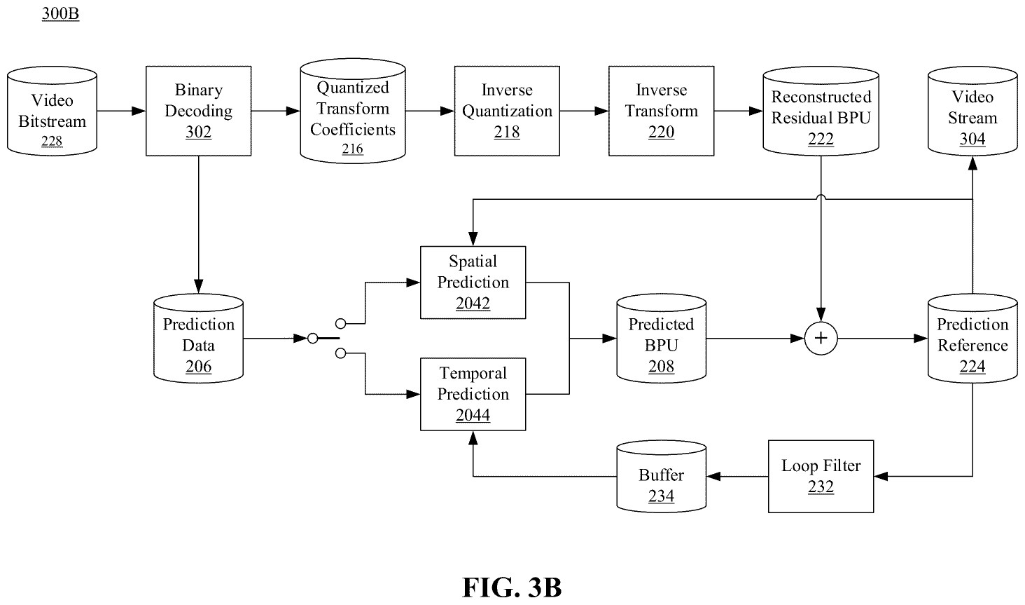

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

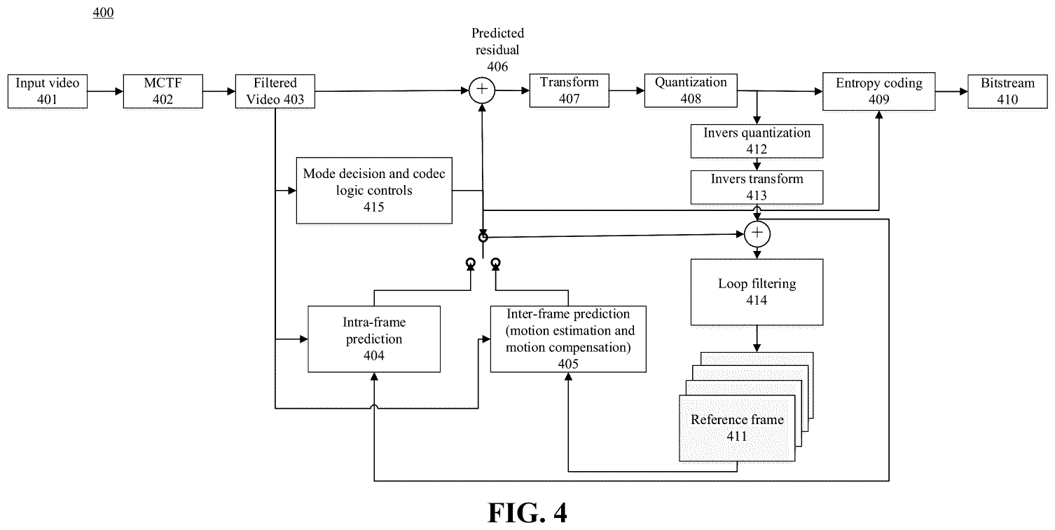

FIG. 4 is a schematic diagram of an application scenario of an exemplary motion compensation method, according to some embodiments of the present disclosure. The method in the embodiments of the present disclosure can be applied to VVC of the video coding standard H.266. Specifically, it can be applied to the Motion Compensated Temporal Filter (MCTF) as shown in FIG. 4 and the motion estimation and motion compensation in inter-frame prediction. MCTF is applied in a pre-processing of VVC mainly to filter the input original video in the time domain through bilateral filters, which can effectively reduce video noise and improve coding efficiency.

The coding process 400 of H.266, as shown in FIG. 4, specifically includes: filtering an input video 401 by MCTF 402 to obtain a filtered video 403, performing intra-frame prediction 404 and inter-frame prediction 505 on the filtered video 403 to obtain a prediction residual 406, performing integer transform on the prediction residual 406, transforming 407 from the spatial domain to the frequency domain, then quantizing 408 the transformed coefficients, producing one-dimensional data from the quantized coefficients through a specific scanning method, and extracting information therefrom and entropy coding 409 the information to obtain a bit stream 410 and send the bit stream 410 to a user terminal for decoding and playback. In order to provide a reference frame 411 for prediction, the codec needs to reconstruct the image, perform inverse quantization 412 and inverse transform 413 through the inverse operation of encoding to obtain the residual image, then add the residual image with the prediction value obtained by intra-frame prediction 404 or inter-frame prediction 405, and then perform loop filtering 414 to obtain the reference frame 411. Mode decision and codec logic controls 415 are used to determine the mode and logic of coding based on specific needs.

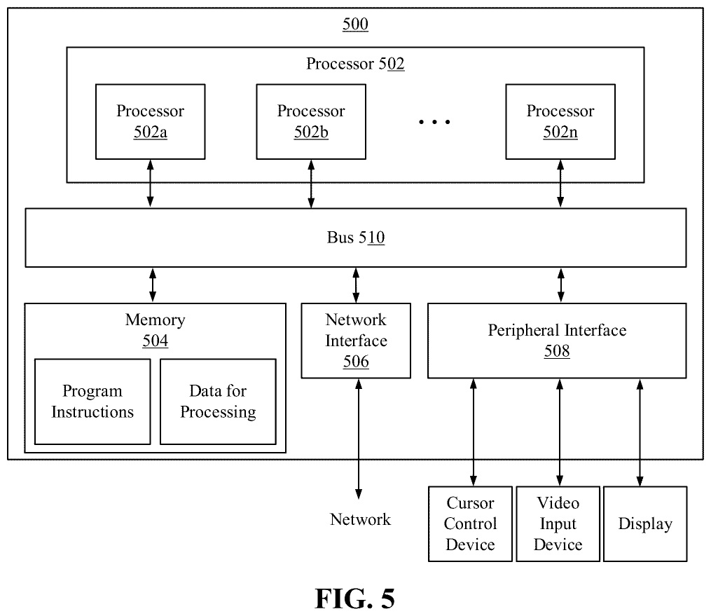

FIG. 5 is a block diagram of an example apparatus 500 for encoding or decoding a video, consistent with embodiments of the disclosure. As shown in FIG. 5, apparatus 500 can include processor 502. When processor 502 executes instructions described herein, apparatus 500 can become a specialized machine for video encoding or decoding. Processor 502 can be any type of circuitry capable of manipulating or processing information. For example, processor 502 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 502 can also be a set of processors grouped as a single logical component. For example, as shown in FIG. 5, processor 502 can include multiple processors, including processor 502a, processor 502b, and processor 502n.

Apparatus 500 can also include memory 504 configured to store data (e.g., a set of instructions, computer codes, intermediate data, or the like). For example, as shown in FIG. 5, the stored data can include program instructions (e.g., program instructions for implementing the stages in processes 200A, 200B, 300A, 300B, or 400) and data for processing (e.g., video sequence 202, video bitstream 228, video stream 304, or input video 401). Processor 502 can access the program instructions and data for processing (e.g., via bus 510), and execute the program instructions to perform an operation or manipulation on the data for processing. Memory 504 can include a high-speed random-access storage device or a non-volatile storage device. In some embodiments, memory 504 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 504 can also be a group of memories (not shown in FIG. 5) grouped as a single logical component.

Bus 510 can be a communication device that transfers data between components inside apparatus 500, such as an internal bus (e.g., a CPU-memory bus), an external bus (e.g., a universal serial bus port, a peripheral component interconnect express port), or the like.

For ease of explanation without causing ambiguity, processor 502 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 500.

Apparatus 500 can further include network interface 506 to provide wired or wireless communication with a network (e.g., the Internet, an intranet, a local area network, a mobile communications network, or the like). In some embodiments, network interface 506 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 500 can further include peripheral interface 508 to provide a connection to one or more peripheral devices. As shown in FIG. 5, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, 300B, or 400) can be implemented as any combination of any software or hardware modules in apparatus 500. For example, some or all stages of process 200A, 200B, 300A, 300B, or 500 can be implemented as one or more software modules of apparatus 500, such as program instructions that can be loaded into memory 504. For another example, some or all stages of process 200A, 200B, 300A, 300B, or 400 can be implemented as one or more hardware modules of apparatus 500, such as a specialized data processing circuit (e.g., an FPGA, an ASIC, an NPU, or the like).

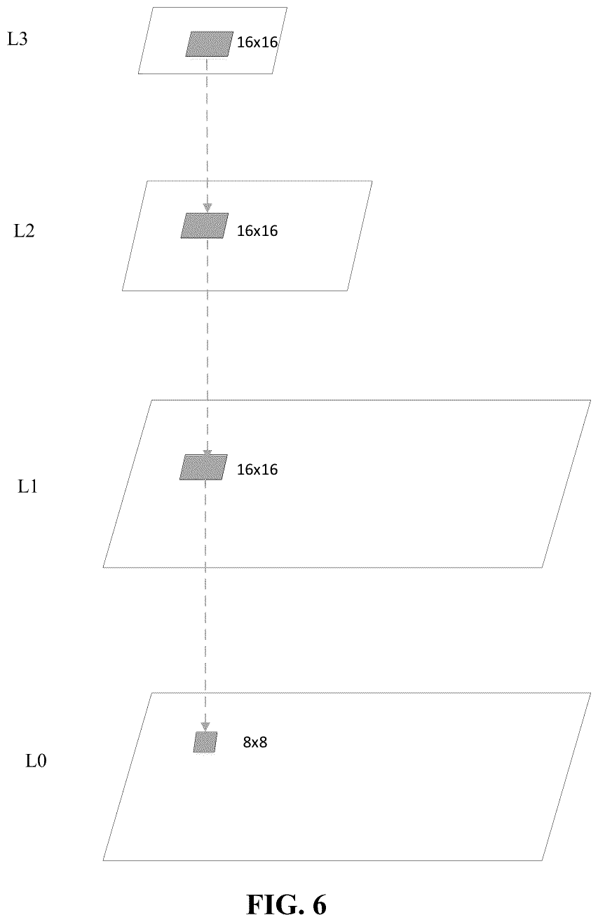

FIG. 6 is a schematic diagram of hierarchical motion estimation by MCTF, according to some embodiments of the present disclosure. The MCTF adopts a hierarchical motion estimation scheme, as shown in FIG. 6, where L0 is the image with the original resolution, L1 is the down-sampled image of L0, and L2 is the down-sampled image of L1. The width and height of L1 are half of those of L0, and the width and height of L2 are half of those of L1. The calculation process of MCTF motion estimation is as follows:
(1) Performing integer pixel motion estimation on each 16×16 block in L3 to obtain an optimal motion vector MV0;
(2) Taking the motion vector MV0 as the initial value, performing the same integer pixel motion estimation on each 16×16 block in L2, to obtain an optimal motion vector MV1;
(3) Taking the motion vector MV1 as the initial value, performing the same integer pixel motion estimation on each 16×16 block in L1, to obtain the optimal motion vector MV2; and
(4) Taking the motion vector MV2 as the initial value, and performing integer pixel motion estimation and sub-pixel motion estimation sequentially on each 8×8 block in L0. For example, first, the integer pixels are searched, that is, the matching costs between the to-be-processed block and the respective pixel blocks corresponding to a plurality of integer pixels within the search range in the reference frame are acquired to obtain an optimal integer pixel. Then, with the optimal integer pixel as the center, an optimal sub-pixel is searched for, that is, the matching costs between the to-be-processed block and the respective pixel blocks corresponding to a plurality of sub-pixels within the search range in the reference frame are acquired. Between the optimal integer pixel and optimal sub-pixel, the optimal pixel is determined according to the magnitude of the matching costs, and the motion vector corresponding to the optimal pixel is taken as the final motion vector MV3. Motion compensation and bilateral filtering are performed by using the motion vector MV3.

When searching the sub-pixels, the number of sub-pixels to be searched is relatively large. For example, if the MV precision is 1/16, then there are 15 sub-pixels between every two integer pixels. It is necessary to search all the sub-pixels sequentially to acquire the matching costs of the sub-pixels, and the search is very complicated.

In order to solve the problems mentioned above, in a related art, all the sub-pixels within the range between every two integer pixels are sequentially traversed, and the sub-pixel search is reduced by a certain step size. Although this solution can reduce the complexity to a certain extent, it has large performance loss and still requires searching of some sub-pixels.

In another related art, the search method of traversing all sub-pixels is optimized, and the complexity of this solution can be reduced to a certain extent by searching from large step size to small step size. However, some sub-pixels still need to be searched, therefore, the sub-pixel search complexity is not reduced to the greatest extent.

In view of this, embodiments of the present disclosure provide a motion compensation method. In the method, first, matching costs between a to-be-processed block and a plurality of first pixel blocks are acquired, the first pixel blocks being pixel blocks corresponding to integer pixels within a search range in a reference frame. Then, based on the plurality of matching costs, the matching costs between the to-be-processed block and a plurality of second pixel blocks are estimated to obtain a plurality of approximate matching costs, the second pixel blocks being pixel blocks corresponding to the sub-pixels within the search range in the reference frame. Finally, motion compensation is performed on the to-be-processed block according to the plurality of matching costs and the plurality of approximate matching costs. In this example, based on the matching costs between the to-be-processed block and the respective pixel blocks corresponding to the plurality of integer pixels within the search range in the reference frame, the matching costs between the to-be-processed block and the respective pixel blocks corresponding to the plurality of sub-pixels within the search range in the reference frame are estimated to obtain the approximate matching costs, so that it is not necessary to search the sub-pixels, thereby reducing the search complexity.

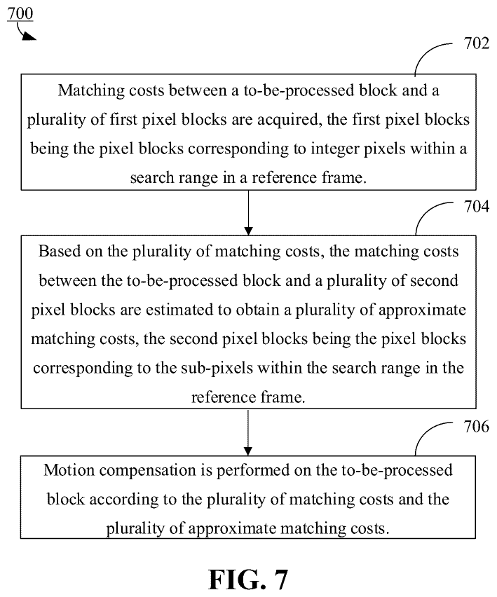

FIG. 7 shows a flowchart of an exemplary motion compensation method 700, according to some embodiments of the present disclosure. Method 700 includes steps 702 to 706.

At step 702, matching costs between a to-be-processed block and a plurality of first pixel blocks are acquired. The first pixel blocks are the pixel blocks corresponding to integer pixels within a search range in a reference frame.

At step 704, based on the plurality of matching costs, the matching costs between the to-be-processed block and a plurality of second pixel blocks are estimated to obtain a plurality of approximate matching costs. The second pixel blocks are the pixel blocks corresponding to the sub-pixels within the search range in the reference frame.

At step 706, motion compensation is performed on the to-be-processed block according to the plurality of matching costs and the plurality of approximate matching costs.

The method can be applied to a computing device, which may include a server, a user terminal, and the like. The to-be-processed block may be a pixel block divided from an image frame for motion estimation and motion compensation. Each pixel block includes at least one pixel. A search range is determined in the reference frame in advance, and integer pixel search is performed starting from the initial search point in the search range. Calculation is made based on the pixel values of the various integer pixels in the data block with the searched integer pixel at the upper left corner and the to-be-processed block to obtain a matching cost as the matching cost corresponding to the searched integer pixel. The matching cost is used to measure the degree of similarity between pixels. The greater the matching cost is, the less similar the respective pixels in two images are.

The plurality of sub-pixels are pixels between the plurality of integer pixels, and at least one sub-pixel is included between every two integer pixels. Based on the matching costs between the to-be-processed block and the respective pixel blocks corresponding to a plurality of integer pixels within the search range in the reference frame, that is, the respective matching costs corresponding to the plurality of integer pixels, the matching costs between the to-be-processed block and the respective pixel blocks corresponding to the plurality of sub-pixels within the search range in the reference frame are estimated to obtain the approximate matching costs between the to-be-processed block and the respective pixel blocks corresponding to the plurality of sub-pixels within the search range in the reference frame, that is, the approximate matching costs corresponding to the plurality of sub-pixels, so that it is unnecessary to search sub-pixels to obtain the matching costs of the sub-pixels. The calculation method for estimation may include a variety of methods, for example, estimation through fitting and interpolation.

After obtaining the respective matching costs corresponding to the plurality of integer pixels and the respective approximate matching costs corresponding to the plurality of sub-pixels, an optimal pixel is determined according to the respective matching costs corresponding to the plurality of integer pixels and the respective approximate matching costs corresponding to the plurality of sub-pixels. Based on the motion vector of the optimal pixel, a matching block for the to-be-processed block is determined in the reference frame to perform motion compensation on the to-be-processed block.

In the motion compensation method provided by embodiments of the present disclosure, first, matching costs between a to-be-processed block and a plurality of first pixel blocks is acquired, the first pixel blocks being pixel blocks corresponding to integer pixels within a search range in a reference frame. Then, based on the plurality of matching costs, matching costs between the to-be-processed block and a plurality of second pixel blocks are estimated to obtain a plurality of approximate matching costs, the second pixel blocks being pixel blocks corresponding to the sub-pixels within the search range in the reference frame. Finally, motion compensation is performed on the to-be-processed block according to the plurality of matching costs and the plurality of approximate matching costs. In this embodiment, based on the matching costs between the to-be-processed block and the respective pixel blocks corresponding to the plurality of integer pixels within the search range in the reference frame, the matching costs between the to-be-processed block and the respective pixel blocks corresponding to the plurality of sub-pixels within the search range in the reference frame are estimated to obtain the approximate matching costs, so that it is not necessary to search the sub-pixels, thereby reducing the search complexity.

The specific implementation method of estimating the approximate matching costs of a plurality of sub-pixels based on the respective matching costs corresponding to a plurality of integer pixels is detailed in the following embodiments.

In some embodiments, step 704 of, based on the plurality of matching costs, estimating matching costs between the to-be-processed block and a plurality of second pixel blocks to obtain a plurality of approximate matching costs includes steps 7021 and 7022.

At step 7021, a coordinate system is established with any one of the plurality of integer pixels as the origin, and fitting calculation is performed based on the respective coordinates and the plurality of matching costs corresponding to the plurality of integer pixels to obtain a fitting function.

At step 7022, respective approximate matching costs corresponding to the plurality of sub-pixels are obtained based on the fitting function and the respective coordinates corresponding to the plurality of sub-pixels in the coordinate system.

The fitting function may include any one of a polynomial function, a power function, and a logarithmic function.

The coordinate system is established with any one of the plurality of integer pixels as the origin. The horizontal axis, vertical axis and each quadrant of the coordinate system include a plurality of integer pixels and a plurality of sub-pixels. Through fitting calculation using the respective coordinates and matching costs corresponding to a plurality of integer pixels, a polynomial function, a power function, a logarithmic function or the like can be fitted. By inputting the respective coordinates corresponding to the plurality of sub-pixels in the coordinate system into the fitting function, results of interpolation calculation, that is, the respective approximate matching costs corresponding to the plurality of sub-pixels can be obtained.

During actual fitting and interpolation calculations, different integer pixels will be used for fitting and interpolation according to different positions of the sub-pixels, specifically as detailed in the following embodiment.

In an implementation, in step 7021, performing fitting calculation based on the coordinates and a plurality of matching costs of a plurality of integer pixels to obtain a fitting function includes: performing fitting calculation based on the coordinates and a plurality of matching costs of the plurality of integer pixels on the horizontal axis of the coordinate system to obtain a fitting function. In step 7022, obtaining a plurality of approximate matching costs based on the fitting function and the coordinates of the plurality of sub-pixels in the coordinate system includes: obtaining the approximate matching costs of the plurality of sub-pixels between the plurality of integer pixels on the horizontal axis of the coordinate system using the coordinates of the plurality of sub-pixels between the plurality of integer pixels on the horizontal axis of the coordinate system and the fitting function.

In some embodiments, the approximate matching costs of the plurality of sub-pixels between three integer pixels on the horizontal axis can be obtained through fitting and interpolation calculations using these three integer pixels.

In this example, because the matching costs of adjacent pixels are highly correlated, the approximate matching costs of the sub-pixels on the horizontal axis can be obtained using the three integer pixels on the horizontal axis. The fitting function can satisfy the corresponding relationship and the performance loss is little.

In some embodiments, in step 7021, performing fitting calculation based on the coordinates and a plurality of matching costs of a plurality of integer pixels to obtain a fitting function includes: performing fitting calculation based on the coordinates and the plurality of matching costs of the plurality of integer pixels on the vertical axis of the coordinate system to obtain a fitting function. In step 7022, obtaining a plurality of approximate matching costs based on the fitting function and the coordinates of the plurality of sub-pixels in the coordinate system includes: obtaining the approximate matching costs of the plurality of sub-pixels between the plurality of integer pixels on the vertical axis of the coordinate system using the coordinates of the plurality of sub-pixels between the plurality of integer pixels on the vertical axis of the coordinate system and the fitting function.

In some embodiments, the approximate matching costs of a plurality of sub-pixels between three integer pixels on the vertical axis can be obtained through fitting and interpolation calculations using these three integer pixels.

In this example, because the matching costs of adjacent pixels are highly correlated, the approximate matching costs of the sub-pixels on the vertical axis can be obtained using the three integer pixels on the vertical axis. The fitting function can satisfy the corresponding relationship, and the performance loss is little.

In some embodiments, in step 7021, performing fitting calculation based on the coordinates and a plurality of matching costs of a plurality of integer pixels to obtain a fitting function includes: performing fitting calculation based on the coordinates and the plurality of matching costs of the plurality of integer pixels on the horizontal axis and vertical axis in a plurality of quadrants of the coordinate system to obtain a fitting function. In step 7022, obtaining a plurality of approximate matching costs based on the fitting function and the coordinates of the plurality of sub-pixels in the coordinate system includes: obtaining the approximate matching costs of the plurality of sub-pixels in the plurality of quadrants using the coordinates of the plurality of sub-pixels in the plurality of quadrants and the fitting function.

In some embodiments, fitting and interpolation calculations are performed using the matching costs of the integer pixels on the positive half-axis of the horizontal axis and the integer pixels on the positive half-axis of the vertical axis, as well as the integer pixels corresponding to the coordinate origin to obtain the approximate matching costs of the sub-pixels in the first quadrant.

In this example, because the matching costs of adjacent pixels are highly correlated, the approximate matching costs of the plurality of sub-pixels in a plurality of quadrants are obtained through fitting and interpolation calculations using the plurality of integer pixels on the horizontal axis and vertical axis in the plurality of quadrants. The fitting function can satisfy the corresponding relationship, and the performance loss is little.

The specific implementation process of the technical solution of the present application is explained below with a specific example.

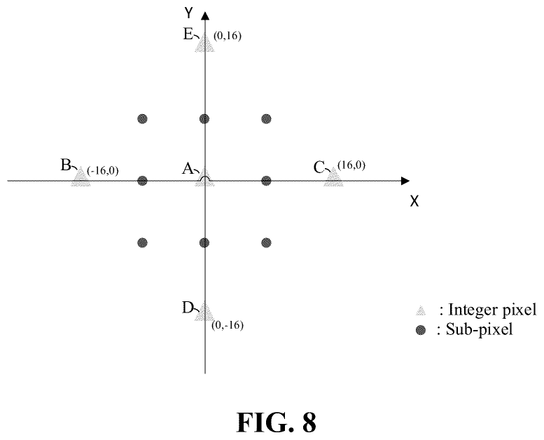

FIG. 8 is a schematic diagram of exemplary sub-pixel search, according to some embodiments of the present disclosure. As shown in FIG. 8, the point A is an optimal integer pixel in an 8×8-block integer-pixel search, and the points B, C, D, and E are four integer pixels above, below, left and right of the optimal point A. The MV precision in this example is 1/16, so there are 15 sub-pixels between two integer pixels, and only one sub-pixel is denoted in FIG. 8. The description will be given based on estimating the matching cost of one sub-pixel as an example. Taking the optimal integer point A as the origin, the integer pixels (e.g., point B and point C) in the horizontal direction as the X-axis, the integer pixels (e.g., point D and point E) in the vertical direction as the Y-axis, and the matching cost “cost” of the point A as the Z-axis, an XYZ coordinate system is established. For example, the coordinates of point A are (0, 0, cost_{A}), the coordinates of point B are (−16, 0, cost_{B}), the coordinates of point C are (16, 0, cost_{C}), the coordinates of point D are (0, −16, cost_{D}), and the coordinates of point E are (0, 16, cost_{E}). In FIG. 8, the two-dimensional coordinates composed of the X-axis and Y-axis in the XYZ coordinate system is taken as an example for explanation. The coordinates of point A are (0, 0), the coordinates of point B are (−16, 0), the coordinates of point C are (16, 0), the coordinates of point D are (0, −16), and the coordinates of point E are (0, 16). The calculation process of the embodiments of the present application is as follows:

1) The “cost” of the sub-pixels on the X and Y coordinate axes is interpolated. The three integer pixels A, B and C are used to fit a₀, b₀, and c₀ in the following parabola formula (1), and then a₀x₀²+b₀x₀+c₀ is used to interpolate the approximate matching cost “cost” of the sub-pixel at the x₀ position on the X coordinate axis. Similarly, the three integer pixels A, D, and E are used to fit the coefficients a₁, b₁ and c₁ in the following parabola formula (2), and then a₁y₀²+b₁y₀+c₁ is used to interpolate the “cost” of the sub-pixel at the y₀ position on the Y coordinate axis.

2) The “cost” of the sub-pixels out of the coordinate axes is interpolated. The three integer pixels A, C, and E are used to fit a₂, b₂ and c₂ in the plane equation of the following formula (3), and then a₂x₀+b₂y₀+c₂ is used to interpolate the “cost” of the sub-pixel at the (x₀, y₀) position in the first quadrant; and the same method is adopted in calculation for the remaining three quadrants.

3) The “costs” of all sub-pixels and the integer pixel a are compared in their values, and the point with the smallest “cost” is selected as the optimal search point.

$${z}_{0} = {a}_{0} {x}^{2} + {b}_{0} x + {c}_{0} \qquad ( 1 )$$

$${z}_{1} = {a}_{1} {y}^{2} + {b}_{1} y + {c}_{1} \qquad ( 2 )$$

$${z}_{2} = {a}_{2} x + {b}_{2} y + {c}_{2} \qquad ( 3 )$$

In an implementation, the step 706 of performing motion compensation on the to-be-processed block according to the plurality of matching costs and the plurality of approximate matching costs includes: determining an optimal integer pixel and an optimal sub-pixel according to the plurality of matching costs and the plurality of approximate matching costs, and determining an optimal pixel between the optimal integer pixel and the optimal sub-pixel; taking the motion vector corresponding to the optimal pixel as the optimal motion vector, and performing motion compensation on the to-be-processed block using the optimal motion vector.

Specifically, according to the respective matching costs corresponding to the plurality of integer pixels, the one with the smallest matching cost is taken as the optimal integer pixel; and according to the respective approximate matching costs corresponding to the plurality of sub-pixels, the one with the smallest approximate matching cost is taken as the optimal sub-pixel. Between the optimal integer pixel and the optimal sub-pixel, the one with the smallest matching cost is selected as the optimal pixel within the search range to obtain the optimal motion vector. The matching block of the to-be-processed block is determined using the optimal motion vector for motion compensation.

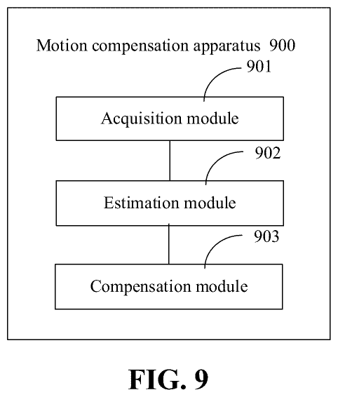

Corresponding to the application scenarios and approaches of the method provided by the embodiments of the present application, the embodiments of the present disclosure further provide a motion compensation apparatus. FIG. 9 is a structural block diagram of an exemplary motion compensation apparatus 900, according to some embodiments of the present disclosure. The apparatus 900 includes an acquisition module 901, an estimation module 902, and a compensation module 903.

Acquisition module 901 includes circuitry configured to acquire matching costs between a to-be-processed block and a plurality of first pixel blocks; the first pixel blocks being pixel blocks corresponding to integer pixels within a search range in a reference frame.

Estimation module 902 includes circuitry configured to, based on the plurality of matching costs, estimate matching costs between the to-be-processed block and a plurality of second pixel blocks to obtain a plurality of approximate matching costs; the second pixel blocks being pixel blocks corresponding to the sub-pixels within the search range in the reference frame.

Compensation module 903 includes circuitry configured to perform motion compensation on the to-be-processed block according to the plurality of matching costs and the plurality of approximate matching costs.

With the motion compensation apparatus provided by embodiments of the present disclosure, first, matching costs between a to-be-processed block and a plurality of first pixel blocks are acquired, the first pixel blocks being pixel blocks corresponding to integer pixels within a search range in a reference frame. Then, based on the plurality of matching costs, matching costs between the to-be-processed block and a plurality of second pixel blocks are estimated to obtain a plurality of approximate matching costs, the second pixel blocks being pixel blocks corresponding to the sub-pixels within the search range in the reference frame. Finally, motion compensation is performed on the to-be-processed block according to the plurality of matching costs and the plurality of approximate matching costs. In this embodiment, based on the matching costs between the to-be-processed block and the respective pixel blocks corresponding to the plurality of integer pixels within the search range in the reference frame, the matching costs between the to-be-processed block and the respective pixel blocks corresponding to the plurality of sub-pixels within the search range in the reference frame are estimated to obtain the approximate matching costs, so that it is not necessary to search the sub-pixels, thereby reducing the search complexity.

In some embodiments, estimation module 902 further includes circuitry configured to: establish a coordinate system with any one of the plurality of integer pixels as the origin, and perform fitting calculation based on the coordinates and the plurality of matching costs of the plurality of integer pixels to obtain a fitting function; and obtain a plurality of approximate matching costs based on the fitting function and the coordinates of a plurality of sub-pixels in the coordinate system.

In some embodiments, estimation module 902 further includes circuitry configured to: perform fitting calculation based on the coordinates and a plurality of matching costs of the plurality of integer pixels on the horizontal axis of the coordinate system to obtain the fitting function; and estimation module 902 further includes circuitry configured to: obtain the approximate matching costs of the plurality of sub-pixels between the plurality of integer pixels on the horizontal axis of the coordinate system using the coordinates of the plurality of sub-pixels between the plurality of integer pixels on the horizontal axis of the coordinate system and the fitting function.

In some embodiments, estimation module 902 further includes circuitry configured to: perform fitting calculation based on the coordinates and a plurality of matching costs of the plurality of integer pixels on the vertical axis of the coordinate system to obtain a fitting function; and estimation module 902 further includes circuitry configured to: obtain the approximate matching costs of the plurality of sub-pixels between the plurality of integer pixels on the vertical axis of the coordinate system using the coordinates of the plurality of sub-pixels between the plurality of integer pixels on the vertical axis of the coordinate system and the fitting function.

In some embodiments, estimation module 902 further includes circuitry configured to: perform fitting calculation based on the plurality of matching costs of the plurality of integer pixels on the horizontal axis and vertical axis in a plurality of quadrants of the coordinate system to obtain a fitting function; and estimation module 902 further includes circuitry configured to: obtain the approximate matching costs of the plurality of sub-pixels in the plurality of quadrants using the coordinates of the plurality of sub-pixels in the plurality of quadrants and the fitting function.

In some embodiments, the fitting function includes any one of a polynomial function, a power function and a logarithmic function.

In some embodiments, motion compensation module 903 further includes circuitry configured to: determine an optimal integer pixel and an optimal sub-pixel according to a plurality of matching costs and a plurality of approximate matching costs, and determine an optimal pixel between the optimal integer pixel and the optimal sub-pixel; take the motion vector corresponding to the optimal pixel as the optimal motion vector, and perform motion compensation on the to-be-processed block using the optimal motion vector.

The functions of various modules in various apparatus of the embodiments of the present disclosure can be found in the corresponding description of the foregoing methods, and they provide corresponding beneficial effects, which will not be described again here.

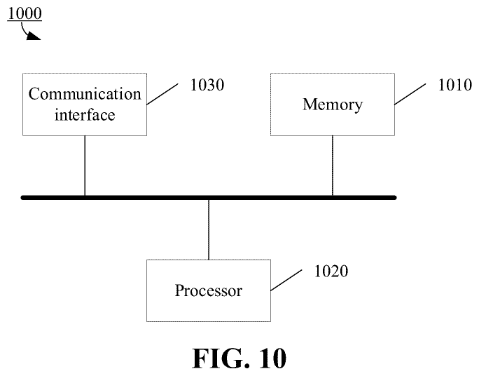

FIG. 10 is a block diagram of an exemplary electronic device 1000, according to some embodiments of the present disclosure. As shown in FIG. 10, electronic device 1000 includes: a memory 1010 and a processor 1020. The memory 1010 has a computer program stored therein that can run on the processor 1020. The processor 1020 implements the method in the above embodiments when executing the computer program. The number of the memory 1010 and processor 1020 may be one or more.

The electronic device 1000 further includes a communication interface 1030 configured to communicate with external devices for data interactive transmission.

If the memory 1010, the processor 1020 and the communication interface 1030 are implemented independently, the memory 1010, the processor 1020 and the communication interface 1030 can be connected to each other through a bus and communicate with each other. The bus may be an Industry Standard Architecture (ISA) bus, a Peripheral Component Interconnect (PCI) bus, an Extended Industry Standard Architecture (EISA) bus, or the like. The bus may be classified into an address bus, a data bus, a control bus and the like. For ease of illustration, it is represented by only one thick line in FIG. 10, but this does not mean that there is only one bus or one type of bus.

In some embodiments, in terms of specific implementation, if the memory 1010, the processor 1020 and the communication interface 1030 are integrated on one chip, the memory 1010, the processor 1020 and the communication interface 1030 can communicate with each other through the internal interface.

The embodiments of the present disclosure further provide a computer-readable storage medium having a computer program stored thereon, which, when executed by the one or more processor, implements the method provided by the embodiments of the present disclosure.

The embodiments of the present disclosure further provide a chip including a processor to call and run instructions stored in the memory, so that the communication device equipped with the chip executes the method provided by the embodiments of the present application.

Embodiments of the present disclosure further provide a chip, including: an input interface, an output interface, a processor, and a memory. The input interface, the output interface, the processor, and the memory are connected through an internal connection path. The processor is configured to execute the code in the memory. When the code is executed, the processor is configured to execute the method provided by the embodiments of the present application.

The embodiments may further be described using the following clauses:

1. A motion compensation method, comprising:
acquiring a plurality of matching costs between a to-be-processed block and a plurality of first pixel blocks, the plurality of first pixel blocks corresponding to a plurality of integer pixels within a search range in a reference frame;
based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and
performing motion compensation on the to-be-processed block according to the plurality of matching costs and the plurality of approximate matching costs.

2. The method according to clause 1, wherein based on the plurality of matching costs, estimating matching costs between the to-be-processed block and the plurality of second pixel blocks to obtain the plurality of approximate matching costs comprises:
establishing a coordinate system with one of the plurality of integer pixels as an origin;
performing fitting calculation based on coordinates and the plurality of matching costs of the plurality of integer pixels to obtain a fitting function; and
obtaining the plurality of approximate matching costs based on the fitting function and coordinates of the plurality of sub-pixels in the coordinate system.

3. The method according to clause 2, wherein performing fitting calculation based on the coordinates and the plurality of matching costs of the plurality of integer pixels to obtain the fitting function comprises:
performing fitting calculation based on coordinates and the plurality of matching costs of a plurality of integer pixels on a horizontal axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the horizontal axis of the coordinate system using coordinates of the plurality of sub-pixels between the plurality of integer pixels on the horizontal axis of the coordinate system and the fitting function.

4. The method according to clause 2, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a vertical axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the vertical axis of the coordinate system using coordinates of the plurality of sub-pixels between the plurality of integer pixels on the vertical axis of the coordinate system and the fitting function.

5. The method according to clause 2, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a horizontal axis and a vertical axis in a plurality of quadrants of the coordinate system to obtain a fitting function; and
obtaining the plurality of approximate matching costs based on the fitting function and the coordinates of the plurality of sub-pixels in the coordinate system comprises:
obtaining approximate matching costs of the plurality of sub-pixels in the plurality of quadrants using coordinates of the plurality of sub-pixels in the plurality of quadrants and the fitting function.

6. The method according to any one of clauses 2 to 5, wherein the fitting function comprises any one of:
a polynomial function, a power function, or a logarithmic function.

7. The method according to clause 1, wherein performing motion compensation on the to-be-processed block according to the plurality of matching costs and the plurality of approximate matching costs comprises:
determining an optimal integer pixel and an optimal sub-pixel according to the plurality of matching costs and the plurality of approximate matching costs, and determining an optimal pixel between the optimal integer pixel and the optimal sub-pixel;
determining an optimal motion vector to be a motion vector corresponding to the optimal pixel; and
performing motion compensation on the to-be-processed block using the optimal motion vector.

8. A motion compensation apparatus, comprising:
an acquisition module configured to acquire matching costs between a to-be-processed block and a plurality of first pixel blocks; the first pixel blocks being pixel blocks corresponding to integer pixels within a search range in a reference frame;
an estimation module configured to, based on the plurality of matching costs, estimate matching costs between the to-be-processed block and a plurality of second pixel blocks to obtain a plurality of approximate matching costs; the second pixel blocks being pixel blocks corresponding to sub-pixels within the search range in the reference frame; and
a compensation module configured to perform motion compensation on the to-be-processed block according to the plurality of matching costs and the plurality of approximate matching costs.

9. An electronic device, comprising a memory, a processor, and a computer program stored on the memory, the processor implementing the method of any one of clauses 1 to 7 when executing the computer program.

10. A computer-readable storage medium having a computer program stored thereon, the computer program, when executed by the processor, implementing the method of any one of clauses 1 to 7.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A motion compensation method, comprising:
acquiring a plurality of matching costs between a to-be-processed block and a plurality of first pixel blocks, the plurality of first pixel blocks corresponding to a plurality of integer pixels within a search range in a reference frame;
based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and
performing motion compensation on the to-be-processed block according to the plurality of matching costs and the plurality of approximate matching costs.

2. The method according to claim 1, wherein based on the plurality of matching costs, estimating matching costs between the to-be-processed block and the plurality of second pixel blocks to obtain the plurality of approximate matching costs comprises:
establishing a coordinate system with one of the plurality of integer pixels as an origin;
performing fitting calculation based on coordinates and the plurality of matching costs of the plurality of integer pixels to obtain a fitting function; and
obtaining the plurality of approximate matching costs based on the fitting function and coordinates of the plurality of sub-pixels in the coordinate system.

3. The method according to claim 2, wherein performing fitting calculation based on the coordinates and the plurality of matching costs of the plurality of integer pixels to obtain the fitting function comprises:
performing fitting calculation based on coordinates and the plurality of matching costs of a plurality of integer pixels on a horizontal axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the horizontal axis of the coordinate system using coordinates of the plurality of sub-pixels between the plurality of integer pixels on the horizontal axis of the coordinate system and the fitting function.

4. The method according to claim 2, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a vertical axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the vertical axis of the coordinate system using coordinates of the plurality of sub-pixels between the plurality of integer pixels on the vertical axis of the coordinate system and the fitting function.

5. The method according to claim 2, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a horizontal axis and a vertical axis in a plurality of quadrants of the coordinate system to obtain a fitting function; and
obtaining the plurality of approximate matching costs based on the fitting function and the coordinates of the plurality of sub-pixels in the coordinate system comprises:
obtaining approximate matching costs of the plurality of sub-pixels in the plurality of quadrants using coordinates of the plurality of sub-pixels in the plurality of quadrants and the fitting function.

6. The method according claim 2, wherein the fitting function comprises any one of:
a polynomial function, a power function, or a logarithmic function.

7. The method according to claim 1, wherein performing motion compensation on the to-be-processed block according to the plurality of matching costs and the plurality of approximate matching costs comprises:
determining an optimal integer pixel and an optimal sub-pixel according to the plurality of matching costs and the plurality of approximate matching costs, and determining an optimal pixel between the optimal integer pixel and the optimal sub-pixel;
determining an optimal motion vector to be a motion vector corresponding to the optimal pixel; and
performing motion compensation on the to-be-processed block using the optimal motion vector.

8. An apparatus for motion compensation, the apparatus comprising:
a memory configured to store instructions; and
one or more processors configured to execute the instructions to cause the apparatus to perform operations comprising:
acquiring a plurality of matching costs between a to-be-processed block and a plurality of first pixel blocks, the plurality of first pixel blocks corresponding to a plurality of integer pixels within a search range in a reference frame;
based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and
performing motion compensation on the to-be-processed block according to the plurality of matching costs and the plurality of approximate matching costs.

9. The apparatus according to claim 8, wherein based on the plurality of matching costs, estimating matching costs between the to-be-processed block and the plurality of second pixel blocks to obtain the plurality of approximate matching costs comprises:
establishing a coordinate system with one of the plurality of integer pixels as an origin;
performing fitting calculation based on coordinates and the plurality of matching costs of the plurality of integer pixels to obtain a fitting function; and
obtaining the plurality of approximate matching costs based on the fitting function and coordinates of the plurality of sub-pixels in the coordinate system.

10. The apparatus according to claim 9, wherein performing fitting calculation based on the coordinates and the plurality of matching costs of the plurality of integer pixels to obtain the fitting function comprises:
performing fitting calculation based on coordinates and the plurality of matching costs of a plurality of integer pixels on a horizontal axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the horizontal axis of the coordinate system using coordinates of the plurality of sub-pixels between the plurality of integer pixels on the horizontal axis of the coordinate system and the fitting function.

11. The apparatus according to claim 9, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a vertical axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the vertical axis of the coordinate system using coordinates of the plurality of sub-pixels between the plurality of integer pixels on the vertical axis of the coordinate system and the fitting function.

12. The apparatus according to claim 9, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a horizontal axis and a vertical axis in a plurality of quadrants of the coordinate system to obtain a fitting function; and
obtaining the plurality of approximate matching costs based on the fitting function and the coordinates of the plurality of sub-pixels in the coordinate system comprises:
obtaining approximate matching costs of the plurality of sub-pixels in the plurality of quadrants using coordinates of the plurality of sub-pixels in the plurality of quadrants and the fitting function.

13. The apparatus according to claim 9, wherein the fitting function comprises any one of:
a polynomial function, a power function, or a logarithmic function

14. The apparatus according to claim 8, wherein performing motion compensation on the to-be-processed block according to the plurality of matching costs and the plurality of approximate matching costs comprises:
determining an optimal integer pixel and an optimal sub-pixel according to the plurality of matching costs and the plurality of approximate matching costs, and determining an optimal pixel between the optimal integer pixel and the optimal sub-pixel;
determining an optimal motion vector to be a motion vector corresponding to the optimal pixel; and
performing motion compensation on the to-be-processed block using the optimal motion vector.

15. A non-transitory computer readable medium that stores a set of instructions that is executable by one or more processors of an apparatus to cause the apparatus to perform operations comprising:
acquiring a plurality of matching costs between a to-be-processed block and a plurality of first pixel blocks, the plurality of first pixel blocks corresponding to a plurality of integer pixels within a search range in a reference frame;
based on the plurality of matching costs, estimating matching costs between the to-be-processed block and a plurality of second pixel blocks to obtain a plurality of approximate matching costs, the plurality of second pixel blocks corresponding to a plurality of sub-pixels within the search range in the reference frame; and
performing motion compensation on the to-be-processed block according to the plurality of matching costs and the plurality of approximate matching costs.

16. The non-transitory computer readable medium according to claim 15, wherein based on the plurality of matching costs, estimating matching costs between the to-be-processed block and the plurality of second pixel blocks to obtain the plurality of approximate matching costs comprises:
establishing a coordinate system with one of the plurality of integer pixels as an origin;
performing fitting calculation based on coordinates and the plurality of matching costs of the plurality of integer pixels to obtain a fitting function; and
obtaining the plurality of approximate matching costs based on the fitting function and coordinates of the plurality of sub-pixels in the coordinate system.

17. The non-transitory computer readable medium according to claim 16, wherein performing fitting calculation based on the coordinates and the plurality of matching costs of the plurality of integer pixels to obtain the fitting function comprises:
performing fitting calculation based on coordinates and the plurality of matching costs of a plurality of integer pixels on a horizontal axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the horizontal axis of the coordinate system using coordinates of the plurality of sub-pixels between the plurality of integer pixels on the horizontal axis of the coordinate system and the fitting function.

18. The non-transitory computer readable medium according to claim 16, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a vertical axis of the coordinate system to obtain the fitting function; and
obtaining the plurality of approximate matching costs based on the fitting function and the coordinates of the plurality of sub-pixels in the coordinate system comprises:
obtaining approximate matching costs of the plurality of sub-pixels between the plurality of integer pixels on the vertical axis of the coordinate system using coordinates of the plurality of sub-pixels between the plurality of integer pixels on the vertical axis of the coordinate system and the fitting function.

19. The non-transitory computer readable medium according to claim 16, wherein performing fitting calculation based on the coordinates and the plurality of matching costs of the plurality of integer pixels to obtain the fitting function comprises:
performing fitting calculation based on coordinates and the plurality of matching costs of the plurality of integer pixels on a horizontal axis and a vertical axis in a plurality of quadrants of the coordinate system to obtain a fitting function; and
obtaining the plurality of approximate matching costs based on the fitting function and the coordinates of the plurality of sub-pixels in the coordinate system comprises:
obtaining approximate matching costs of the plurality of sub-pixels in the plurality of quadrants using coordinates of the plurality of sub-pixels in the plurality of quadrants and the fitting function.

20. The non-transitory computer readable medium according to claim 15, wherein performing motion compensation on the to-be-processed block according to the plurality of matching costs and the plurality of approximate matching costs comprises:
determining an optimal integer pixel and an optimal sub-pixel according to the plurality of matching costs and the plurality of approximate matching costs, and determining an optimal pixel between the optimal integer pixel and the optimal sub-pixel;
determining an optimal motion vector to be a motion vector corresponding to the optimal pixel; and
performing motion compensation on the to-be-processed block using the optimal motion vector.
